(19) United States
(12) Patent Application Publication
(10) Pub. No.: US 2013/0187423 A1
(43) Pub. Date: Jul. 25, 2013

(54) ADJUSTMENT DEVICE FOR ADJUSTING A MOTOR VEHICLE SEAT, MOTOR VEHICLE SEAT, MOTOR VEHICLE AND METHOD FOR ADJUSTING A MOTOR VEHICLE SEAT

(71) Applicant: GM Global Technology Operations LLC, Detroit, MI (US)

(72) Inventor: Andrzej PLESKOT, Trebur (DE)

(73) Assignee: GM GLOBAL TECHNOLOGY OPERATIONS LLC, Detroit, MI (US)

(21) Appl. No.: 13/746,537

(22) Filed: Jan. 22, 2013

(30) Foreign Application Priority Data
Jan. 25, 2012 (DE) 102012001281.0

(51) Int. Cl. B60N 2/22; B60N 2/16

(52) U.S. Cl. CPC B60N 2/22; B60N 2/16
USPC 297/311; 297/354.12

(57) ABSTRACT

An adjustment device for adjusting a motor vehicle seat is provided. The adjustment device includes a locking arrangement with a rotation axis about which a backrest part and a seat part are able to be folded with respect to one another. The adjustment device also includes an adapter arrangement and an operating unit fixed on the adapter arrangement and arranged remote from the rotation axis. A motor vehicle seat, a motor vehicle, and a method for adjusting a motor vehicle seat using the adjustment device are also provided.

### CROSS-REFERENCE TO RELATED APPLICATION

This application claims priority to German Patent Application No. 10 2012 001 281.0, filed Jan. 25, 2012, which is incorporated herein by reference in its entirety.

### TECHNICAL FIELD

The technical field relates to an adjustment device for adjusting a motor vehicle seat, a vehicle seat including the adjustment device, a motor vehicle including the vehicle seat, and a method for adjusting a motor vehicle seat using the adjustment device.

### BACKGROUND

Seat arrangements with adjustment devices for motor vehicles are generally known. Conventionally, the known seat arrangements have a seat part and a backrest part, which are foldably connected by means of a folding mechanism or an adjustment device, more precisely a backrest adjustment device. A lever for triggering the folding movement is conventionally arranged directly on a rotation axis of the seat backrest or respectively of the adjustment device or its locking arrangement. This position is unergonomic and poorly accessible for a user sitting on the vehicle seat. In known solutions, therefore, an arrangement of the lever on the seat part is provided, in particular in a region of the seat height adjustment. However, the installation space which is available for an operating unit is relatively small here, so that only special operating levers can be provided. In addition, owing to the cramped installation space, a transmission of force is only possible conditionally with operating levers of smaller size. Through the special operating levers, furthermore, functions are impaired, for example the function of an airbag in the seat region, in particular its unfolding, through the altered position of the operating lever. Also, a play between the rotation axis on the backrest part and the rotation axis on the seat part is great, so that a problem-free function is not guaranteed.

A vehicle seat with an adjustment device for the backrest is known from DE 38 00 924 C2, consisting of a stationary bearing mount, and a swivel arm mounted swivelably on the bearing mount. The swivel arm is fastened to the backrest and is able to be fixed by means of a locking arrangement in selectable angle positions. The adjustment device is concealed by a covering part in the direction of the seat user. The bearing mount is fastened on the seat part and the remaining parts of the adjustment device are arranged inside the backrest and are connected with it. The covering part is securely connected with a part of the adjustment device and has a slit into which an upwardly projecting region of the bearing mount dips when the backrest is folded forward. For operating comfort of the adjustment device, an actuating unit or operating unit is provided, which is placed back into an initial position by means of its resetting mechanism.

It is therefore at least one object herein to provide a vehicle seat with an adjustment device, which ensures an ergonomically positioned operating unit with a high degree of operating comfort with a reliable mode of operation. It is also desirable to provide a motor vehicle seat, a motor vehicle with a corresponding vehicle seat, and a method for adjusting the motor vehicle seat by means of the adjustment device. In addition, other objects, desirable features and characteristics will become apparent from the subsequent summary and detailed description, and the appended claims, taken in conjunction with the accompanying drawings and this background.

### SUMMARY

In an exemplary embodiment, an adjustment device for adjusting a motor vehicle seat, in particular a discontinuous adjustment device for adjusting a backrest position of the motor vehicle seat, includes at least one locking arrangement with a rotation axis about which a backrest part and a seat part are able to be folded with respect to one another. An adapter arrangement is provided by which an operating unit is able to be arranged remote from the rotation axis.

In an embodiment, an adjusting of a backrest or of a backrest part takes place by the application of a force onto the backrest or respectively the backrest part. The backrest is preferably prestressed here, so that a prestressing force acts in the direction of an upright seat position and contrary to a swiveled-back position. In order to swivel the backrest or the backrest part, a force is preferably exerted by a user sitting on the seat, for example by leaning against the backrest. So that an unintentional adjustment of the backrest is prevented, the adjustment device comprises a locking device or detent, which prevents the unintentional adjustment. In an embodiment, the detent is constructed as a detent fitting unit, in which two detent fitting parts act with one another. For an adjustment, these are to be unlocked, so that a seat adjustment can take place. The adjustment device comprises the detent fitting unit. On locking, the two detent fitting parts are in engagement, for example by means of a toothing. In order to enable an adjustment, the detent fitting parts are moved apart, so that they are no longer in engagement. In an embodiment, the force necessary for this or respectively the movement for this is transmitted via a force transmission arrangement. On the relative movement of the two detent fitting parts there are various intermediate positions between the two end positions or end states—locking and release—during the moving apart. In some of these intermediate positions an adjustment is possible, although the detent fitting parts are still slightly in engagement. In order to move the detent fitting parts apart, the force transmission arrangement is provided, by which a force for locking and unlocking is able to be transmitted at least to the detent fitting unit. The force results here accordingly in a relative movement of the detent fitting parts. In an embodiment, in order to use a force which is transmitted via the force transmission arrangement onto the detent fitting unit so that an adjustment only takes place on a complete moving apart of the detent fitting parts, a force translation unit is provided. The force transmission arrangement is constructed to carry out the state in which the detent fitting parts are completely remote from one another and an adjustment is to be carried out without contact of the detent fitting parts, more quickly and with a noticeable feedback to the operator. For this, the transmitting force, which in the prior art is transmitted substantially proportionally or linearly to the path, is translated by means of the force transmission arrangement, in particular is translated in a variable manner. In an embodiment, the force transmission arrangement and the force translation unit are constructed in an integrated manner. Preferably, the translation takes place degressively, so that on reaching a decoupling point, i.e. a point or state at which the detent fitting parts are entirely no longer in engagement, noticeably less force is to be applied onto the force transmission arrangement, therefore a corresponding feedback is given to the operator. The adjustment device is constructed here so that the force transmission arrangement becomes more smooth-running when the decoupling point or a decoupling state is reached. In an embodiment, one force transmission arrangement is provided. In other embodiments, several force transmission arrangements are provided, for example two, three or more. In an embodiment, the several force transmission arrangements are coupled, for example connected in series or connected in parallel. A further embodiment provides one force translation unit. A further embodiment provides several force translation units. In an embodiment, the several force translation units are coupled, for example connected in series or connected in parallel. In an embodiment, the force transmission arrangement is constructed as a lever, gear or the like, i.e. the force transmission arrangement comprises a translation section in which a force is translated. The force is, however, translated independently of an angle or a path of the force transmission arrangement, so that a predetermined translation ratio is always present. The force translation unit provides an additional translation. In particular, the force translation unit is constructed such that different translation ratios are able to be realized. For this, the force translation unit is able to be changed relative to the force transmission arrangement, in particular is able to be moved, for example translatorily and/or rotatorily.

In order to operate or actuate the adjustment device, an operating unit is provided. In an embodiment, the operating unit comprises a translation unit, which is constructed for example as a rotary lever. In another embodiment, the translation unit is constructed as a carrier on which an operating lever sits. The translation unit is preferably arranged on a rotation axis of the adjustment device, in order to move the seat part and the backrest part about it and to thus bring about an unlocking of the adjustment device or respectively the locking arrangement. The operating unit is accordingly coupled with the translation unit. So that the locking arrangement does not remain in an unlocked state, but rather is always returned into a blocking or locking state, a resetting mechanism or respectively a resetting arrangement is provided. In an embodiment, the resetting arrangement is constructed at least partially in an integrated manner in a traction force element. The traction force element connects two lateral locking arrangements of the adjustment device which are spaced apart laterally from one another. Preferably, the traction force element is constructed as a cable-like element which is constructed substantially for traction force transmission. A pressure force is not or substantially not or respectively negligibly transmitted.

In another embodiment, the adjustment device for adjusting a motor vehicle seat, in particular a discontinuous adjustment device for adjusting a backrest position of the motor vehicle seat or respectively of a backrest part relative to a seat part of the motor vehicle seat, comprises at least two locking arrangements, which are able to be actuated via at least one operating unit. The locking arrangements can be connected here in series with the operating unit.

The motor vehicle seat comprises a backrest or a backrest part and a seat part. The backrest part and the seat part are connected adjustably with one another via an adjustment device. The adjustment device has a rotation axis here, about which the backrest part is swivelable or foldable relative to the seat part, so that an angle between the seat part and the backrest part is able to be adjusted according to the wishes of the user. In order to arrest the backrest part in a desired position, the adjustment device has at least one locking arrangement. Preferably, a locking arrangement is provided on each side of the motor vehicle seat or respectively of the adjustment device.

In an embodiment, the adjustment device has two locking arrangements, one on each side of the motor vehicle seat. The locking arrangements have respectively a separate locking mechanism. So that the locking arrangements unlock the adjustment device in synchronism, these are connected or respectively coupled with one another. In an embodiment, the connection is configured in parallel. Preferably, the locking arrangements are connected in series. Furthermore, for the synchronous opening of the locking arrangements, a corresponding synchronization is necessary. The coupling of the two locking arrangements is preferably carried out via a traction force element, for example, by a Bowden cable.

In an embodiment, each locking arrangement has a lever unit, via which the locking arrangement is able to be actuated and/or one which is to be transferred is able to be translated. The lever unit is arranged in a torque-proof manner on a rotation axis of the locking arrangement. On an actuation, i.e. a rotation, of the lever unit, the rotation axis is co-rotated, and the locking arrangement is unlocked, so that the backrest or respectively the backrest part can be adjusted. The lever unit preferably functions as a force translation unit and/or as a force transmission unit.

The operating unit is arranged in a region of the actuating unit or operating unit for a vertical adjustment of the seat part in an embodiment. Such a positioning of the operating unit ensures, on the one hand, an operating unit which is readily accessible and ergonomically positioned for a user. Furthermore, a safety arrangement such as an airbag is unimpaired by the correspondingly positioned operating unit, i.e. it is fully functional.

In an embodiment, the backrest part and the seat part are connected directly and foldably with one another. In other embodiments, the seat backrest and the seat part are connected foldably with one another by means of (adapter) parts arranged therebetween. The (adapter) parts are constructed for example as an (adapter) part on the seat part side and an (adapter) part on the backrest side. The part on the seat part side is connected with the seat part or respectively is integrated into the latter. The part on the backrest side is connected with the seat backrest or respectively is integrated into the latter. In an embodiment, the part on the backrest side is connected with a supporting structure of the backrest part, in particular with a backrest shell part of the seat backrest. In the following, the term “seat part” will be used synonymously for the seat part and the (adapter) part on the seat part side, or respectively the term “backrest part” will be used synonymously for the backrest part and the (adapter) part on the backrest side, in so far as they are not described expressly differently.

The adjustment device is advantageously constructed in several parts, in order to enable a reliable folding of the components. In particular, the adjustment device has a part on the seat part side and a part on the backrest side. In an embodiment, the part on the seat part side is integrated into the seat part and/or the part on the backrest side is integrated into the backrest part. In other embodiments, the parts are constructed separately and are arranged for example on the seat part or respectively on the backrest part or respectively are connected therewith.

Both parts are connected rotatably or respectively foldably with one another about the first rotation axis, for example by means of a fitting of the backrest adjustment device. For example, the adjustment device has a (rotary) joint, hinge or suchlike. A locking of the folding is able to be carried out for example via detent elements of the device.

Advantageously, the folding of the backrest part is able to be actuated by means of at least one operating unit. In an embodiment, just one operating unit is constructed. Other embodiments provide more than one, for example two or three operating units. Preferably one operating unit is constructed per seat arrangement and/or adjustment devices. In an embodiment, the operating unit is arranged spaced apart from the first rotation axis of the backrest part, preferably spaced apart radially. This radial spacing ensures an ergonomic position on the seat arrangement, readily accessible by a user. Furthermore, through this spacing a functional impairment by the operating unit to further arrangements, for example an airbag in the region of the seat arrangement, is avoided. In an embodiment, the operating unit is arranged on a part on the seat part side, i.e. the seat part, of the adjustment device. The operating unit is preferably arranged in a stationary manner on the seat part. In an embodiment, the operating unit is constructed as a lever unit. The lever unit preferably has at least one lever arm.

The adjustment device has an adapter arrangement for the ergonomic and functionally reliable arrangement of the operating unit. The adapter arrangement comprises the adapter part on the seat part side. In another embodiment, the adapter arrangement comprises an adapter part on the backrest part side. In a further other embodiment, the adapter arrangement comprises an adapter part both on the backrest side and also on the seat side. The respective adapter part is constructed so as to be stationary in relation to the first rotation axis of the adjustment device or respectively of the locking arrangement. The operating unit is fixed on the adapter arrangement, so that the operating unit is securely spaced in relation to the first rotation axis serving as reference point.

Accordingly, an embodiment makes provision that the adapter arrangement is arranged in a stationary manner with respect to the locking arrangement. In particular, the adapter arrangement is arranged in a stationary manner with respect to the first rotation axis. In this way, all components which are fixed on the adapter arrangement are also fixed with respect to the first rotation axis of the locking arrangement or respectively the adjustment device.

In an embodiment, provision is made that the operating unit comprises an actuating lever, via which the adjustment device is able to be actuated. The actuating lever is preferably constructed as a lever which can also be used directly on the first rotation axis of the locking arrangement. A force translation is able to be realized via the actuating lever on operating the operating unit to the locking arrangement. In an embodiment, the actuating lever is constructed as a rotary lever.

In a further embodiment, the operating unit is arranged at least partially in a region of an operating unit for a seat height adjustment. The seat height adjustment is arranged in the region of the seat part. Accordingly also an operating unit for the seat height adjustment is arranged adjacent thereto on the seat part. Accordingly, the operating unit arranged there for the adjustment device is coupled via a coupling or respectively via the adapter arrangement with the first rotation axis.

In addition, an embodiment makes provision that a translation unit is provided, which carries out a force translation from the operating unit to the rotation axis. In this way, an ergonomic operating of the adjustment device is realized. Preferably, the operating unit is able to be operated with a torque of less than or equal to 3.5 Nm, for example, of less than or equal to 2.5 Nm.

In an embodiment, the operating unit has a carrier, via which the rotary lever is arranged on a second rotation axis. The adapter arrangement comprises the second rotation axis, about which the operating unit is rotatably mounted. Accordingly, the second rotation axis is securely spaced from the first rotation unit. In this way, a lever mechanism is able to be used as transmission- and/or translation unit. Preferably, the rotary lever of the operating unit is rotatably mounted via the carrier on the second rotation axis.

Another further embodiment makes provision that the carrier is coupled with the translation unit. The coupling of the carrier, which is preferably constructed as a rotary lever, with the translation unit, which is preferably likewise constructed as a rotary lever, takes place preferably via a traction force element, for example, a cable-like traction force element, such as a Bowden cable. Owing to the fixing of the second rotation axis to the first rotation axis, a transmission or respectively translation is also able to be realized by means of lever.

Accordingly, in an embodiment, the second rotation axis is arranged in a stationary manner on the adapter arrangement. More precisely, the second rotation axis is fixed in a stationary manner on a backrest adapter and/or a seat adapter. The backrest adapter and/or seat adapter is fixed for example in a stationary manner on the backrest part or respectively seat part, for example is constructed in an integral manner.

In an embodiment, the translation unit has a lever translation. In order to transmit and/or translate a suitable force for the actuation of the locking arrangement from an, if applicable also smaller, operating lever of the operating unit to the locking arrangement, preferably a lever translation is provided. Owing to different lever arms on the levers or lever units, constructed as rotary levers, a desired force translation or respectively lever translation can thus be provided.

As described, in a further embodiment, the actuating unit or operating unit is constructed so as to be rotatable about a second rotation axis arranged in a stationary manner with respect to the backrest part. The adapter extends accordingly from the first rotation axis into the region of the seat part, more precisely the seat height adjustment. Advantageously, the first, stationary rotation axis of the backrest part and the second, stationary rotation axis of the operating unit are arranged spaced apart from one another. Additionally preferably, the two rotation axes run parallel to one another.

The operating unit has the carrier. The rotary lever of the operating unit is fastened thereon. Accordingly, the second rotation axis of the operating unit advantageously runs through the carrier. In an embodiment, just one carrier is constructed. Other embodiments provide more than one, for example two or three, carriers. For example, the carrier is constructed as a shaping and/or recess, on or respectively into which the operating unit is able to be placed or respectively inserted and/or clipped. For this, the operating unit has a receiving opening, which is cylindrical for example, for placing onto the carrier. The receiving opening and the carrier are preferably constructed in a complementary manner. The fastening of the operating unit is preferably secure against rotation with respect to the carrier. In an embodiment, a play, in particular in rotating direction, between carrier and operating lever is provided. Advantageously, a security is provided, in order to prevent an unintentional releasing of the operating unit from the carrier.

Accordingly, in an embodiment at least one securing element is provided for securing the operating unit on the at least one carrier. In an embodiment, just one securing element is constructed. Other embodiments provide more than one, for example two, three or four securing elements. The securing element is constructed for example as a clip, screw, pin or suchlike. Advantageously, the securing element is integrated into the operating unit and/or into the carrier. In an embodiment, at least one hook-shaped securing element is constructed in the region of the receiving opening of the operating unit.

Accordingly, in another embodiment at least one securing element is constructed as a groove, in particular as a circumferential groove, on the carrier. Preferably, the securing element is constructed in a front region of the carrier, i.e. a region facing away from the seat part. On a placing of the operating unit onto the carrier, the front region projects out from the operating unit. The groove-shaped securing element is then arranged on this region. For example, the securing element is constructed as a groove running around the carrier in a ring shape. In the mounted state, the hook-shaped securing elements of the operating unit cooperate with the groove-shaped securing element, for example by the hooks engaging into the groove and locking there, so that a slipping of the operating unit is prevented.

In a further embodiment, at least one coupling unit is provided, in order to couple the at least one operating unit with at least one translation unit or respectively a lever unit of the locking unit. The coupling unit couples the operating unit with at least one translation unit, in order to enable a remote-controlled or respectively remote-actuated folding movement of the backrest part. An embodiment provides one coupling unit. Other embodiments provide more than one, for example two or three coupling units. In an embodiment, an operating unit is coupled with more than one translation unit, preferably two translation units. The coupling unit couples the two translation units or respectively the rotary levers of the locking arrangement for unlocking the adjustment device, for example serially or parallel with the operating unit. Preferably, the coupling unit is embodied as a traction force element, in particular in the form of a cable-like element such as a Bowden cable.

In addition, in an embodiment, a motor vehicle seat, in particular a motor vehicle seat with a backrest which is adjustable with respect to a seat part, is provided. The motor vehicle seat includes at least one adjustment mechanism for adjusting the backrest. The adjustment mechanism is constructed as the adjustment device described above.

The vehicle seat includes a seat cushion and a seat cover on the backrest part and on the seat part. In an embodiment, the vehicle seat has a facing in the region of the seat part and/or of the backrest part. Advantageously, the operating unit is arranged on a facing in the region of the seat part. Further advantageously, the actuating arrangement and the coupling unit are concealed by the facing and/or by the seat cover or respectively cushion, i.e. are not visible to a user.

In a vehicle seat with the adjustment device described above, the components of a conventional vehicle seat are able to be used. In particular, standard components which are already known can be used for the operating unit and the operating lever, so that an additional manufacturing expenditure can be avoided. The operating levers are able to be exchanged as required via the carrier, without the adjustment device having to be exchanged.

In a further embodiment, a motor vehicle, in particular an automobile, comprising at least one seat unit for a vehicle occupant or respectively with at least one vehicle seat is provided. The at least one vehicle seat is constructed as described above. The motor vehicle is constructed for example as a limousine, station wagon, coupe, sport-utility vehicle, (mini) bus or suchlike. Advantageously, the motor vehicle comprises several seat arrangements described above, with an arrangement according to the adjustment device with an ergonomically arranged operating unit, for example as the driver's, front passenger's and/or rear (bench) seat. Hereby, advantageously any functions of the motor vehicle in the region of the vehicle seats, i.e. for example a side airbag, are guaranteed.

In yet another embodiment, a method for adjusting a motor vehicle seat by means of an adjustment device with at least two locking arrangements, in particular for adjusting a backrest position of the motor vehicle seat by means of a discontinuous adjustment device with at least two locking arrangements, is provided. The method includes the steps of moving an operating unit. The moving is carried out remote from a rotation axis of the locking arrangement.

In particular, an embodiment makes provision that the moving is carried out about a second rotation axis referenced in a stationary manner with respect to the first rotation axis. The adjustment device, more precisely its locking arrangements, each has a rotation axis. The rotation axes of different locking arrangements are aligned here, so that a backrest part is foldable with respect to the seat part about the rotation axes. The rotation axis serves as reference axis for the actuating unit or respectively operating unit. In an operating unit arranged remote from the rotation axis, malfunctions can occur owing to an undesired play. In order to prevent this, an adapter arrangement is provided. This has an adapter or an adapter plate, which is arranged in a stationary manner with respect to the rotation axis. The adapter plate is preferably in a single piece. In addition, the adapter plate extends into the region in which the operating unit is arranged. The adapter plate has the second rotation axis for the rotatable receiving of the operating unit. Owing to the single-piece configuration of the adapter plate, the second rotation axis is securely referenced to the first rotation axis, i.e. arranged at a fixed distance from the first rotation axis. The actuating lever of the operating unit is arranged rotatably on the second rotation axis via a carrier. In order to unlock the locking arrangement and to enable an adjustment of the backrest part, a force is introduced via the operating unit. This takes place by moving the operating unit, in particular by rotating the operating lever about the second rotation axis. The rotating therefore takes place at a distance from the first rotation axis. As the latter is spaced apart in a stationary manner with respect to the second rotation axis, a translation ratio can be set via a corresponding translation unit.

### BRIEF DESCRIPTION OF THE DRAWINGS

The various embodiments will hereinafter be described in conjunction with the following drawing figures, wherein like numerals denote like elements, and wherein:

FIG. 1 is a partial exploded illustration of a cutout of the adjustment device in accordance with an exemplary embodiment;

FIG. 2 schematically illustrates the adjustment device of FIG. 1 with traction force elements in accordance with an exemplary embodiment;

FIG. 3 is a diagrammatic rear view of the cutout of the adjustment device according to FIG. 1 in a partially mounted state; and

FIG. 4 is a side view of a cutout of a motor vehicle seat 200 with the adjustment device 100 according to FIG. 1.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

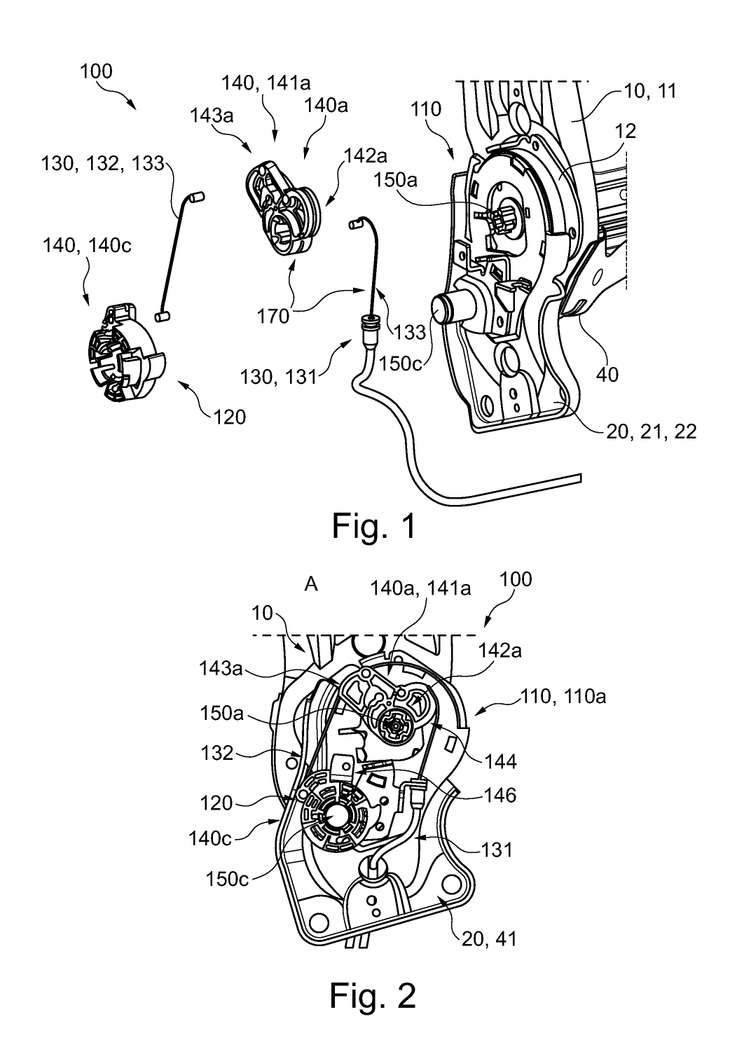

FIGS. 1 to 4 show in different views and different degrees of detail an adjustment device 100 according to an exemplary embodiment.

The adjustment device 100 connects a backrest part 10 of a motor vehicle seat, not illustrated in more detail here, with a seat part 20 of the motor vehicle seat. The backrest part 10 and the seat part 20 are connected foldably with one another or respectively with respect to one another here via the adjustment device 100. The backrest part 10 and the seat part 20 are constructed in two parts, wherein the backrest part 10 has two laterally spaced backrest part sections 11 and the seat part 20 has two corresponding laterally spaced seat part sections 21, of which respectively only one is illustrated. One side of the adjustment device 100 is illustrated respectively. In the embodiment which is illustrated here, the backrest part 10 has additionally a backrest adapter part 12 on each backrest part section 11. The seat part 20 has accordingly on each side section a seat adapter part 22. In the embodiment illustrated here, the seat adapter parts 22 are integrated into the side part sections 21 and therefore into the seat part 20, i.e. are constructed in one piece therewith. On each side, the adjustment device 100 has a locking arrangement 110. The backrest adapter part 12 is part of an adapter arrangement 40, with which an operating unit 120 is able to be arranged remote from a rotation axis 150a of the locking arrangement 110.

The locking arrangements 110 comprise respectively two detent fitting units, which on a locking by the locking arrangements 110 are in engagement with one another and for an unlocking of the locking arrangements 110 are accordingly not in engagement. A detailed description of the adjustment device 100 is made below in connection with FIGS. 1 to 4. Identical or similar components are designated by identical reference numbers. A detailed description of components which have already been described is dispensed with for reasons of a better overview.

FIG. 1 shows diagrammatically a partial exploded illustration of a cutout of the adjustment device 100 in accordance with an exemplary embodiment. The adjustment device 100 comprises, in addition to the locking arrangement 110, the operating unit 120. The backrest part 10 and the seat part 20 are connected foldably with one another via the adjustment device 100. In this embodiment, the seat part 20 and the backrest part 10 are constructed as a supporting structure of the vehicle seat, which is not illustrated completely here, wherein in FIG. 1 only the components which are essential for the immediate understanding of the embodiments are illustrated.

In FIG. 1, in an embodiment, one of the two locking arrangements 110, spaced apart from one another laterally, is illustrated. In order to actuate the two laterally spaced locking arrangements 110 jointly via the shared actuating unit or operating unit 120 and hence to actuate the entire adjustment device 100 via the one shared operating unit 120, the two locking arrangements 110 are coupled with one another. The locking arrangements 110 are connected in series here. This means that the locking arrangements 110 are coupled with one another via a traction force element 130, which is constructed here as a Bowden cable 131.

The illustrated locking arrangement 110 is coupled with the operating unit 120. The coupling of the operating unit 120 with the locking arrangement 110 takes place here likewise via a traction force element 130, which is likewise constructed here as a Bowden cable 132.

A translation unit 140, constructed as lever unit 140a, is provided on the locking arrangement 110 for the actuation of the locking arrangements 110. The lever unit 140a is arranged on a rotation axis 150a of the locking arrangement 110. The lever unit 140a is connected here in a torque-proof manner with the rotation axis 150a. If the lever unit 140a is now rotated, then with the latter the corresponding rotation axis 150a is likewise rotated, whereby the corresponding locking arrangement 110 is unlocked or locked. The respective detent fitting of the locking arrangement 110 preferably has a progressive force-path characteristic here.

In an embodiment, the lever unit 140a has at least one lever arm 142a, via which a force translation can be realized. Through the lever unit 140a, functioning as (force) translation unit and, at the same time, as force transmission unit, any desired force-path characteristic is able to be set on the respectively locking arrangement 110. According to FIG. 1, the illustrated lever unit 140a of the locking arrangement 110 is connected via the Bowden cable 131 with the laterally spaced locking arrangement 110, which is not illustrated here, so that a movement of the lever unit 140a is transmitted to the lever unit, which is not illustrated here. The lever unit 140a is connected in addition via the Bowden cable 132 with a further lever unit 140c of the operating unit 120. The lever unit 140c, like the lever unit 140a, is constructed as a rotatable lever unit 140c and is constructed here in particular as a carrier for an operating lever, not illustrated, of the operating unit 120.

The third lever unit 140c, constructed as a carrier, is rotatable about a rotation axis 150c spaced apart from the rotation axis 150a. The rotation axis 150c is constructed on the adapter arrangement 40. More precisely, the rotation axis 150c is constructed on an adapter plate 41. The adapter plate 41 is constructed as an adapter plate on the seat side or on the backrest side. The adapter plate 41 is arranged in a stationary manner with respect to the first rotation axis 150a, i.e. the distances between points of the adapter plate 41 and of the rotation axis 150a do not change. The further lever unit 140c sits in a torque-proof manner on the rotation axis 150c. The operating unit 120 is able to be arranged via the Bowden cable 132 at a desired location on the seat part 20 via the rotation axis 150c. Preferably, the operating unit 120 is arranged on the motor vehicle seat. The lever unit 140c is rotated by an actuating of the operating unit 120. The movement or respectively the rotatory force is transferred via the Bowden cable 132 to the lever unit 140a and from there via the Bowden cable 131 to the adjacent lever unit. In another embodiment, in order to move the respective lever units 140a, 140c after actuation into their initial position again, a resetting arrangement 170 is provided. The resetting arrangement 170 is constructed partially in at least one of the traction force elements 130, more precisely in an integrated manner in at least one of the Bowden cables 131, 132. For this, the respective Bowden cable 131, 132 has at least one elastic section 133 in the traction direction. Preferably, the respective Bowden cable 131, 132 comprises an elastic material, for example, a spring steel. This is elastically deformable in a predetermined region or respectively the section 133. Accordingly, the spring steel has a spring deflection which is used for a resetting. The two Bowden cables 131, 132 have here an elastically deformable region 133, which ensures the resetting function. The Bowden cable 132 connects the lever unit 140a with the lever unit 140c. The Bowden cable 131 connects the lever unit 140a with the lever unit, not illustrated here, of the adjacent locking arrangement. In this way, the Bowden cables 131, 132 act on the translation unit 140 in different rotation directions.

In a further embodiment, the seat arrangement 20 or respectively the seat part 20 comprises the adapter plate 41, which is part of the adapter arrangement 40. The rotation axis 150c is constructed in the form of a cylindrical shaping on the adapter plate 41. It projects from the seat part 20. The rotation axis 150c serves for fastening the carrier. The adjustment device 100 additionally comprises the operating unit or operating unit 120 for actuating a folding movement of the backrest part 10. The operating unit 120 has a central, cylindrical receiving opening. On mounting of the operating unit 120, the latter is pushed with the receiving opening onto the cylindrical rotation axis 150c. The receiving opening and the rotation axis 150c are constructed in a complementary manner for this. The operating unit 120 is rotatable about the rotation axis 150c. The two rotation axes 150a and 150c are arranged spaced apart from one another.

In addition, the adjustment device comprises several securing elements for securing the operating unit 120, fastened on the rotation axis 150c, against an unintentional releasing. Firstly, in an embodiment, three securing elements are constructed on a front edge of the receiving opening, distributed circumferentially thereon. The term “front” refers here to a side of the operating unit 120 facing away from the seat part 20 in the mounted state. These securing elements are constructed as hook elements which, in the mounted state, cooperate with the rotation axis 150c. Secondly, the rotation axis 150c has a securing element in the form of a groove encircling in a ring shape at a front end. In the mounted state, i.e. when the operating unit is pushed onto the rotation axis 150c, the hook-like securing elements engage into the groove-shaped securing element and are locked there.

The adjustment device also comprises the translation unit 140. The translation unit 140 also has a central, approximately cruciform receiving opening, by means of which the translation unit 140 is able to be placed onto a corresponding rotation axis 150a on the fitting. The translation unit 140 is rotatable about the rotation axis 150a running through the shaping. A rotation of the translation unit 140 causes a folding movement of the backrest part 10.

FIG. 2 shows diagrammatically the adjustment device 100, more precisely a cutout, with the traction force elements 130, in accordance with an exemplary embodiment. On the illustrated side of the adjustment device 100, the lever unit 140a is constructed as rotary lever 141a. The rotary lever 141a is arranged in a torque-proof manner on the rotation axis 150a of the locking arrangement 110a. A lever arm 142a and a lever arm 143a project radially outwards. The Bowden cable 131 is fastened on the lever arm 142a. The Bowden cable 132 is fastened on the lever arm 143a. According to the position of the lever arm 143a, the latter transmits a torque, via the application of force from the Bowden cable 132, to the rotation axis 150a. The torque is passed on, translated by the lever arm 142a, via the Bowden cable 131 to the adjacent locking arrangement 110. The lever arm 142a is constructed with deflection 144. The Bowden cable 132 runs around the latter, snugly against its surface. The Bowden cable 131 runs from the lever arm 143a to the lever unit 140c, constructed as carrier for the operating lever, of the operating unit 120. Both Bowden cables 131, 132 are tensioned in the illustrated embodiment. The lever unit 140c lies against a stop 146, so that a rotation in the direction of the stop 146 is limited. The second rotation axis 150c is constructed on the adapter plate 41. The adapter plate 41 is constructed integrated into the seat part 20. The carrier sits rotatably arranged on the rotation axis 150c. The carrier has corresponding connecting elements for connection with the operating lever.

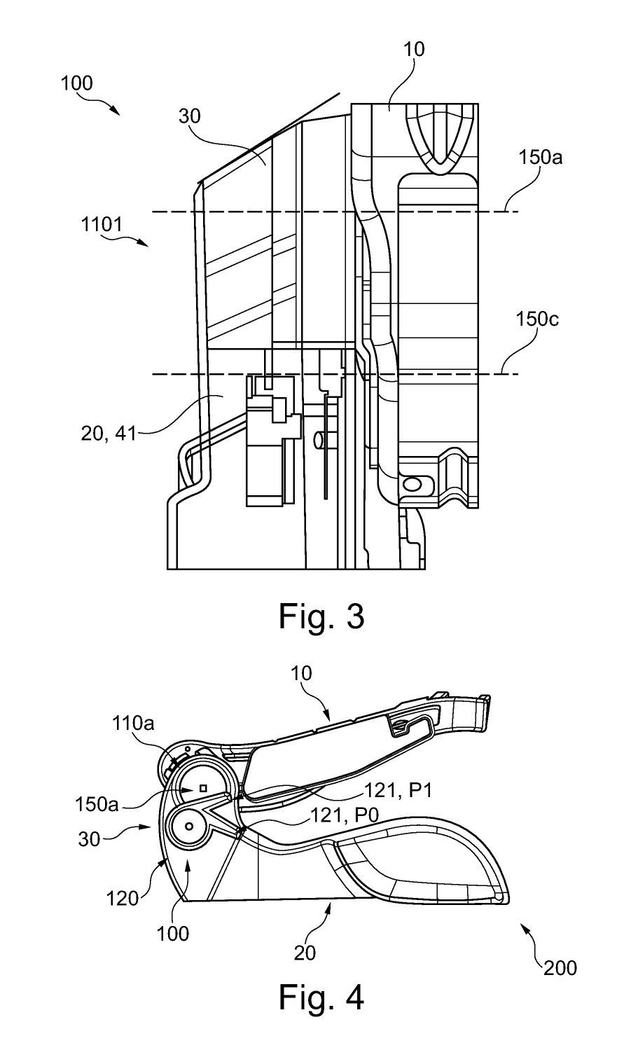

FIG. 3 shows a diagrammatic rear view of the cutout of the adjustment device 100 according to FIG. 1 in a partially mounted state. In the partially mounted state of the adjustment device 100 according to FIG. 3, a facing 30 is arranged on the seat part 20, more precisely on the adapter plate 41. The facing 30 has at its upper region an oblique course, in order to enable an unfolding of a cushion of a side airbag, not illustrated here, of the vehicle seat 200 (see FIG. 4). In the illustration of FIG. 3, in addition the two spaced rotary axes 150a and 150c are indicated. The second rotation axis 150c is arranged further in the direction of a vehicle floor (not shown here), i.e. lower or respectively further downwards, than the first rotation axis 150a of the locking arrangement 110 or respectively of the backrest part 10. The first rotation axis 150a runs here in the range of an inflated airbag cushion. The arrangement of the lower rotation axis 150c is outside the range of the airbag cushion and cannot therefore affect its function. Furthermore, the position of the second rotation axis 150c is substantially simpler to reach for a user and is therefore arranged more ergonomically than the first rotation axis 150a.

FIG. 4 shows diagrammatically in a side view a cutout of a motor vehicle seat 200 with the adjustment device 100 according to FIG. 1. In this view, the motor vehicle seat 200 is folded, i.e. the backrest part 10 is folded or swiveled in the direction of the seat part 20 about the rotation axis 150a of the locking arrangements 110. For this, the operating unit 120, constructed as operating lever 121, is to be moved from an initial position P0 into an operating position P1. The moving takes place by a swiveling about the rotation axis 150c. The operating lever 121 is swiveled back into its initial position P0 by a resetting mechanism. The further construction of FIG. 1 is not illustrated here owing to the facing 30.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. An adjustment device for adjusting a motor vehicle seat, the adjustment device comprising:
a locking arrangement with a rotation axis about which a backrest part and a seat part are able to be folded with respect to one another;
an adapter arrangement;
an operating unit fixed on the adapter arrangement and arranged remote from the rotation axis.

2. The adjustment device according to claim 1, wherein the adjustment device is a discontinuous adjustment device for adjusting a backrest position of the motor vehicle seat.

3. The adjustment device according to claim 1, wherein the adapter arrangement is arranged in a stationary manner with respect to the locking arrangement.

4. The adjustment device according to claim 1, wherein the operating unit comprises an actuating lever via which the adjustment device is able to be actuated.

5. The adjustment device according to claim 1, wherein the operating unit is arranged at least partially in a region of the operating unit for a seat height adjustment.

6. The adjustment device according to claim 1, further comprising a translation unit that realizes a force translation from the operating unit to the rotation axis.

7. The adjustment device according to claim 6, wherein the operating unit has a carrier via which a rotary lever is arranged on a second rotation axis.

8. The adjustment device according to claim 7, wherein the carrier is coupled with the translation unit.

9. The adjustment device according to claim 7, wherein the second rotation axis is arranged in a stationary manner on the adapter arrangement.

10. The adjustment device according to claim 6, wherein the translation unit has a lever translation.

11. A motor vehicle seat with at least one adjustment mechanism for adjusting a backrest of the motor vehicle seat, the at least one adjustment mechanism comprising:
a locking arrangement with a rotation axis about which a backrest part and a seat part are able to be folded with respect to one another;
an adapter arrangement;
an operating unit fixed on the adapter arrangement and arranged remote from the rotation axis.

12. The motor vehicle seat according to claim 11, wherein the backrest of the motor vehicle seat is adjustable with respect to the seat part.

13. A motor vehicle with a seat unit for a vehicle occupant, wherein the seat unit has an adjustment mechanism for adjusting a backrest of the seat unit, the adjustment mechanism comprising:
a locking arrangement with a rotation axis about which a backrest part and a seat part are able to be folded with respect to one another;
an adapter arrangement;
an operating unit fixed on the adapter arrangement and arranged remote from the rotation axis.

14. The motor vehicle according to claim 13, wherein the motor vehicle is an automobile.

15. A method for adjusting a motor vehicle seat using an adjustment device with at least two locking arrangements, the method comprising the steps of:
moving an operating unit, wherein the moving is carried out remote from a first rotation axis of at least one of the at least two locking arrangements.

16. The method according to claim 15, wherein the adjustment device is a discontinuous adjustment device with the at least two locking arrangements and the method results in adjusting a backrest position of the motor vehicle seat.

17. The method according to claim 15, wherein the moving is carried out about a second rotation axis referenced in a stationary manner to the first rotation axis.
